(19) United States
(12) Patent Application Publication
(10) Pub. No.: US 2008/0093175 A1
(43) Pub. Date: Apr. 24, 2008

(54) Spindle device

(76) Inventors: Naomitsu Yanohara, Aichi (JP); Tomoharu Ando, Aichi (JP); Takashi Norihisa, Aichi (JP)

Correspondence Address: JACOBSON HOLMAN PLLC, 400 SEVENTH STREET N.W., SUITE 600, WASHINGTON, DC, 20004, US

(21) Appl. No.: 11/907,759

(22) Filed: Oct. 17, 2007

(30) Foreign Application Priority Data
Oct. 20, 2006 (JP) 2006-286054

(51) Int. Cl. F01M 9/12; F16C 35/08

(52) U.S. Cl. 184/7.1; 384/462

(57) ABSTRACT

An object of the present invention is to provide a spindle device for stabilizing a retainer with a minimum quantity of air to be supplied to the bearing. A spindle device includes: supplying unit which supplies air from three or more points spaced in a circumferential direction between outer races and inner races of bearings supporting a spindle; and control unit which controls a supply quantity of air supplied by the supplying unit in such a manner as to independently vary the supply quantity at each of the supplying points.

### BACKGROUND OF THE INVENTION

1. Field of the Invention

The present invention relates to a spindle device in a machining tool such as a machining center and, more particularly, to a spindle device which stably rotates a retainer for retaining a rolling element in a rolling-element bearing for supporting a spindle.

2. Description of the Related Art

A spindle in a machining tool is rotatably supported by a plurality of rolling-element bearings. The rolling-element bearing includes an inner race, an outer race, a rolling element and a retainer. The inner race is press-fitted to the spindle, to be rotated together with the spindle. In the meantime, the outer race is incorporated in a housing, and further, is securely pressed by a presser cap in an axial direction. The plurality of rolling-elements are movably incorporated between the inner race and the outer race, to be retained by the retainer in such a manner as to be held at equal intervals. The retainer is guided on the rolling-element or at an inner circumferential surface of the outer race, to be rotated together with the rolling-element. A retainer to be guided at the inner circumferential surface of the outer race is often used in most of bearings, each of which is rotated at as high a speed as a Dn value more than 1,500,000. The bearing incorporating therein the retainer to be guided at the inner circumferential surface of the outer race undergoes influences of a surface roughness of the inner circumferential surface of the outer race, a shape precision of the inner circumferential surface of the outer race, a surface roughness of an outer peripheral surface of the retainer, a shape precision of the retainer, a weight of the retainer, a shape precision of the rolling element, a dimensional error of the rolling element incorporated in the bearing, a clearance defined between the inner circumferential surface of the outer race and the outer peripheral surface of the retainer, and an oil film quantity between inner circumferential surface of the outer race and the outer peripheral surface of the retainer. When the spindle is rotated in the state in which the above-described conditions cannot be properly kept, the retainer is unstably rotated. As a result, an abnormal noise or vibration occurs, and therefore, a surface to be machined undergoes an adverse affect, thereby inducing damage on the bearing at the worst.

A device for improving a spindle in the above-described state is exemplified by a bearing in which a pressure fluid flows into a retainer through a plurality of holes formed at an outer race in the bearing (see Japanese Utility Model Application Publication No. 45697/1994).

Otherwise, there has been known a spindle device provided with a device for supplying a lubricant filled into a through hole in a spindle through a plurality of holes formed at an inner race in a bearing to a retainer through a hole formed at the spindle (see Japanese Patent Application Laid-open No. 166548/1999).

In the conventional spindle device, the fluid need be supplied all the time in order to keep a constant clearance between the inner circumferential surface of the outer race of the bearing and the outer peripheral surface of the retainer, thereby increasing the consumption of the fluid. When the fluid to be supplied is the lubricant, the oil film can keep the constant clearance, but heat may be abnormally generated due to an excessive quantity of lubricant in the bearing. In the case of a low circularity of the outer diameter of the retainer or non-uniform deformation caused by the rotation, it may be difficult to constantly keep the clearance between the inner circumferential surface of the outer race of the bearing and the outer peripheral surface of the retainer over the entire circumference. Even if the lubricant can constantly keep an oil film quantity in the clearance, a frictional force locally occurs in the retainer, thereby inducing the fear of occurrence of vibrations.

### SUMMARY OF THE INVENTION

An object of the present invention is to provide a spindle device, in which a retainer can be stabilized with a minimum quantity of fluid to be supplied, and further, a flow rate and direction of fluid to be supplied to a retainer can be varied based on a rotational speed of a spindle, an attitude of the spindle and a value from a sensor fixed to the spindle.

A spindle device according to the present invention includes: supplying unit which supplies fluid from three or more points spaced in a circumferential direction between an outer race and an inner race of a bearing supporting a spindle; and control unit which controls a supply quantity of fluid supplied by the supplying unit in such a manner as to independently vary the supply quantity at each of the supplying points.

In the spindle device according to the present invention, even in the case where, for example, a retainer is rotated off balance, force can be exerted in a direction in which an imbalance is cancelled by regulating the flow rate of fluid through the three or more holes capable of independently supplying the fluid. As a consequence, the imbalance in the retainer can be reduced with a low flow rate of fluid.

Furthermore, in the spindle device, the supply quantity of fluid controlled by the control unit may be determined based on the rotational speed of the spindle.

If the spindle device is equipped with a function of determining the flow rate and position of the fluid to be supplied to the retainer based on the rotational speed of the spindle, a set value can be determined per rotational speed, so that the retainer can be stably held even if the retainer is deformed or vibrated by an influence of the rotational speed. For example, the rotational speed region of the spindle is divided into low, middle and high speed regions, in each of which an optimum flow rate of the fluid is determined, so that the retainer can be stably held in all of the speed regions.

Moreover, in the spindle device, the supply quantity of fluid controlled by the control unit may be determined based on an inclination angle of the spindle.

If the spindle device is equipped with the function of determining the flow rate and position of the fluid to be supplied to the clearance between the retainer and the outer race based on the attitude of the spindle, the retainer can be stably held even if the behavior of the retainer by an influence of the weight of the spindle per se or the weight of the retainer per se is varied with a variation in attitude of the spindle. For example, the flow rate of the fluid is determined based on an inclination of the spindle with respect to a reference position in a machine capable of rotating a spindle device at an arbitrary angle.

Additionally, the spindle device may include a sensor which detects vibration of the spindle, wherein the supply quantity of fluid controlled by the control unit may be determined based on a value detected by the sensor.

If the spindle device is equipped with a function of extracting a value within a predetermined frequency range from information obtained by one or more sensors attached to the spindle device so as to vary the flow rate and position of the fluid to be supplied to the clearance between the retainer and the outer race based on the value, the fluid is supplied at a proper flow rate when the value from the sensor satisfies a condition as the result of a real-time analysis. In the case of this device, every condition can be set according to the characteristics of the sensor. For example, the fluid is supplied at a minimum vibration within a set frequency range by the use of an acceleration sensor in machining with high precision.

According to the present invention, the flow rates and positions of the plurality of fluid supplying holes can be independently set, so that the retainer can be stably rotated in spite of the variation of the rotational speed or the attitude of the spindle. In addition, the flow rate and position of the fluid can be regulated in such a manner as to optimize the value from the sensor attached to the spindle device. Thus, it is possible to produce an effect in finishing requiring for a spindle rotational accuracy, and further, to produce an effect in preventing damage on the bearing caused by abrasion of the retainer.

### BRIEF DESCRIPTION OF THE DRAWINGS

FIG. 1 is a vertically cross-sectional view showing a spindle device according to the present invention;

FIG. 2 is a laterally cross-sectional view showing the spindle device;

FIG. 3 is a cross-sectional view showing a part of FIG. 1 in enlargement;

FIG. 4 is a cross-sectional view showing a modification of a part shown in FIG. 3, being equivalent to FIG. 3;

FIG. 5 is a table illustrating an air supplying quantity; and

FIG. 6 is a diagram explanatory of inclination angles of a spindle.

### DETAILED DESCRIPTION OF THE PREFERRED EMBODIMENT

A detailed description will be given below of a preferred embodiment according to the present invention in reference to the attached drawings.

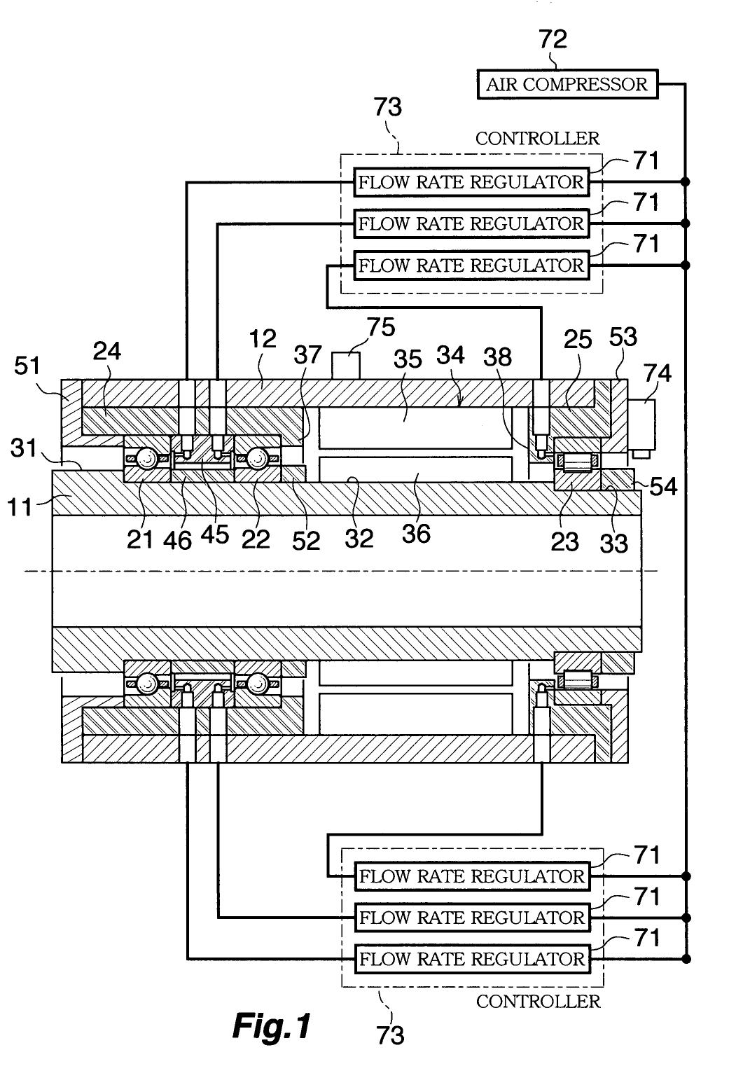

In the description below, a left side in reference to FIG. 1 is referred to as the left, and further, a side opposite to the left side is referred to as a right. In addition, the left is a front side while the right is a rear side.

A spindle device is provided with a hollow spindle 11 having an axis in a horizontal direction, a horizontally cylindrical sleeve 12 fitted around the spindle 11, a first bearing 21 and a second bearing 22 which support the spindle 11 on the left side thereof with an axial interval, a third bearing 23 which supports the spindle 11 on the right side thereof, a left housing 24 which surrounds the first bearing 21 and the second bearing 22 and is fixed to an inner surface of the sleeve 12, and a right housing 25 which surrounds the third bearing 23 and is fixed to the inner surface of the sleeve 12.

At an outer surface of the spindle 11 are formed a large-diameter portion 31, a middle-diameter portion 32 and a small-diameter portion 33 in sequence via steps from left to right.

A stator 35 for a motor 34 is secured to the inner surface of the sleeve 12 between the second bearing 22 and the third bearing 23. Furthermore, a rotor 36 for the motor 34 is secured to the outer surface of the spindle 11 in such a manner as to correspond to the stator 35.

At a left end of an inner surface of the left housing 24 is disposed a left inward annular projection 37. In the meantime, at a right end of an inner surface of the right housing 25 is disposed a right inward annular projection 38.

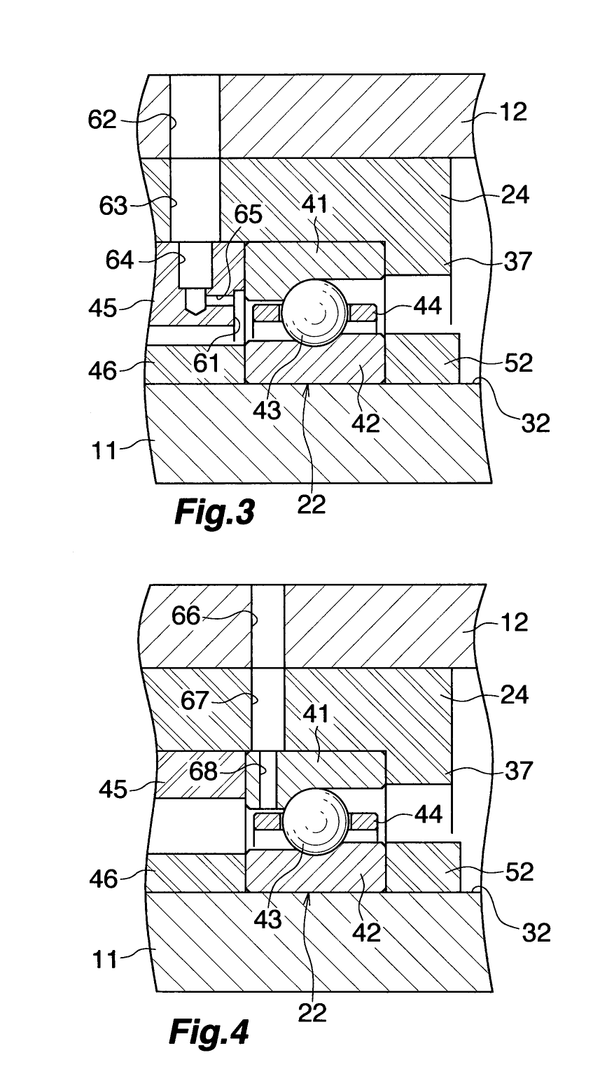

The first to third bearings 21 to 23 have the same structure. FIG. 3 particularly shows the second bearing 22. The second bearing 22 includes an outer race 41 secured to the inner surface of the left housing 24, an inner race 42 secured to the outer surface of the spindle 11, a plurality of rolling elements 43 interposed between the outer race 41 and the inner race 42, and a retainer 44 which is rotated together with the rolling elements 43 under a guidance of an inner surface of the outer race 41 so as to retain the rolling elements 43 at predetermined intervals.

Referring to FIG. 1 again, an outer race inter-seat 45 secured to the inner surface of the left housing 24 is interposed between the outer races 41 of the first bearing 21 and the second bearing 22. In the meantime, an inner race inter-seat 46 secured to the outer surface of the spindle 11 is interposed between the inner races 42 of both of the bearings 21 and 22.

A left opening of the sleeve 12 is capped with a left presser cap 51. The left presser cap 51 presses the outer races 41 of the first bearing 21 and the second bearing 22 toward the left inward annular projection 37 together with the outer race inter-seat 45. A left pressing nut 52 is screwed on a right side of the second bearing 22. The left pressing nut 52 presses the inner races 42 of the first bearing 21 and the second bearing 22 against the step of the large-diameter portion 31 and the middle-diameter portion 32 together with the inner race inter-seat 46. A right opening of the sleeve 12 is capped with a right presser cap 53. The right presser cap 53 presses the outer race 41 of the third bearing 23 toward the right inward annular projection 38. A right pressing nut 54 is screwed on a right side of the third bearing 23. The right pressing nut 54 presses the inner race 42 of the third bearing 23 against the step of the middle-diameter portion 32 and the small-diameter portion 33.

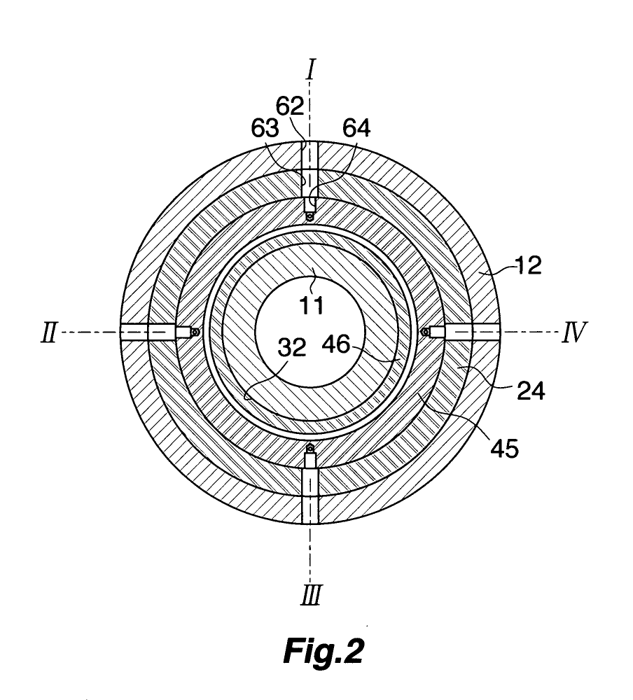

Referring to FIG. 3 again, an inward opening annular groove 61 is formed at the right side surface of the outer race inter-seat 45 in such a manner as to face a clearance defined between the outer race 41 and the inner race 42 in the second bearing 22. At a portion just a left side of the second bearing 22, an outer air supplying hole 62 are formed at the sleeve 12 and an inner air supplying hole 63 are formed at the left housing 24, respectively, in such a manner that an inner air supplying hole 64 is formed at the outer race inter-seat 45 continuously in alignment inward and outward. The annular groove 61 and a bottom of the inner air supplying hole 64 are connected to each other via a communication hole 65. These outer air supplying holes 62, inner air supplying holes 63, inner air supplying holes 64 and communication holes 65 are formed in the same manner on a right side of the first bearing 21 and on a left side of the third bearing 23, respectively. The outer air supplying hole 62, inner air supplying hole 63, inner air supplying hole 64 and communication hole 65 corresponding to each of the bearings 21 to 23 are formed at four points I to IV quartered on the sleeve 12, the housing and the outer race inter-seat 45, as shown in FIG. 2.

FIG. 4 shows a modification of the annular groove 61, the outer air supplying hole 62, the inner air supplying hole 63, the inner air supplying hole 64 and the communication hole 65. In this modification, air is supplied directly to between the outer race 41 and the inner race 42 in the second bearing 22 without any connection between the annular groove 61 and the communication hole 65. An outer air supplying hole 66, an inner air supplying hole 67 and another inner air supplying hole 68 are formed in such a manner as to pass between the outer race 41 and the inner race 42 in the second bearing 22. The inner air supplying hole 68 penetrates inward and outward of the outer race 41 in the second bearing 22.

Returning to FIG. 1, each of the outer air supplying holes 62 is connected to a compressor 72 in an air supplying apparatus via a flow rate regulator 71. Each of the flow rate regulators 71 is controlled by a controller 73.

A rotational speed detecting sensor 74 is attached to a side surface of the right presser cap 53 in such a manner as to expose a right side end of the spindle 11. In addition, an acceleration detecting sensor 75 is attached to an intermediate portion in a longitudinal direction of the outer surface of the sleeve 12.

Next, description will be made on an air supplying operation.

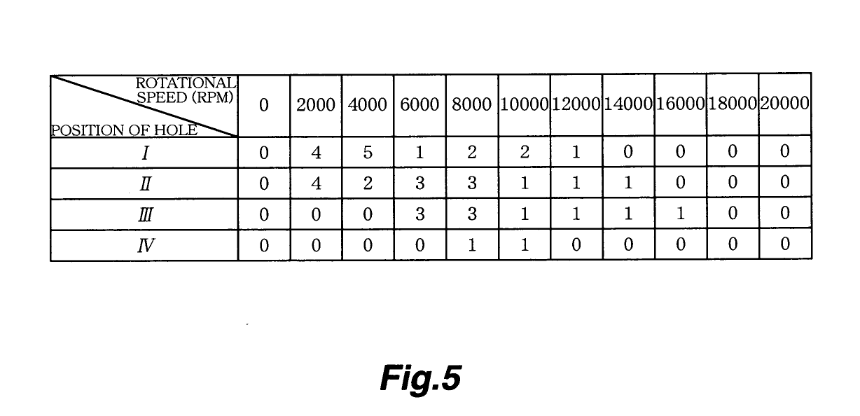

First of all, the rotational speed detecting sensor 74 detects the rotational speed of the spindle 11. Incidentally, the rotational speed may be detected by using a spindle control command value. Upon the detection of the rotational speed, an air flow rate is determined in reference to a previously created table, as illustrated in FIG. 5. The table shows supplying quantities per rotational speed (rpm) of the spindle at the positions I to IV in FIG. 2 at the outer air supplying hole 62, the inner air supplying hole 63 and the inner air supplying hole 64 corresponding to each of the bearings 21 to 23 on six levels 0 to 5. Although the supplying quantity is set per 2000 rpm in the table illustrated in FIG. 5, it may be further divisionally set. Otherwise, in the case of an intermediate rotational speed such as 0 to 2000 rpm or 2000 to 4000 rpm, 0 to 999 rpm, for example, is set to 0 rpm or 1000 to 1999 rpm, for example, is set to 2000 rpm. Set values in the table illustrated in FIG. 5 are set such that an increased air flow rate in one direction keeps a balance since the vibration of the retainer 44 and the imbalance are liable to occur by the large clearance between the outer race 41 and the retainer 44 due to a small centrifugal force of the retainer 44 or a small thermal expansion during low-speed rotation of 0 to 6000 rpm. The air flow rate is set in such a manner as to become small since the vibration of the retainer 44 becomes small caused by the small clearance between the outer race 41 and the retainer 44 during high-speed rotation of 8000 rpm or higher. A command as to the set value is sent to each of the flow rate regulators 71 from the controller 73, to thus regulate the air flow rate.

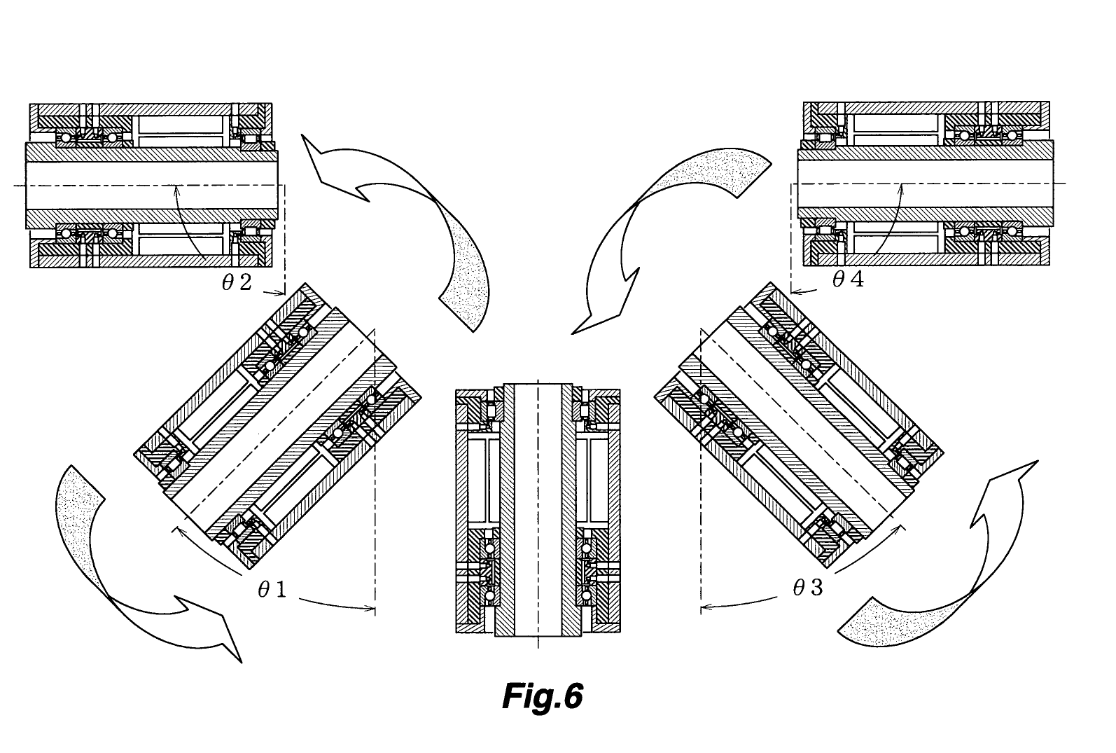

FIG. 6 illustrates the attitude of the spindle 11, that is, inclination angles θ1 to θ4. The inclination angles θ1 to θ4 indicate angles in reference to a vertically downward state of the spindle 11. First, the inclination angles θ1 to θ4 of the spindle 11 are detected. The inclination angle may be detected based on a spindle angle command value or a detection value from an angle detecting sensor fixed to the spindle device. Upon the detection of the inclination angles θ1 to θ4, the air flow rate is determined in reference to a previously created table, not illustrated, in conformance with FIG. 5.

In order to create the table, the following is taken into consideration. The attitude of the retainer 44 for guiding the outer race 41 is varied due to its own weight since the clearance is defined between the inner circumferential surface of the outer race 41 and the rolling element 43. When the inclination angle of the spindle 11 is, for example, 90°, that is, θ2 or θ4, the center of the rotation of the retainer 44 is moved downward. If the rotation is continued as it is, imbalance occurs, thereby possibly generating an abnormal noise or an abnormal vibration. In order to prevent any occurrence of such abnormality, the air flow rate at each of the positions I to IV is set. The table may be created in consideration of the rotational speed. Alternatively, the table illustrated in FIG. 5 created per rotational speed also may be used at the same time.

Subsequently, in the case where the vibration generated in the spindle is detected and the air flow rate is set so as to suppress the vibration, a description will be given by way of one example in which the air flow rate at each of the positions I to IV is set by the use of the rotational speed detecting sensor 74 and the acceleration detecting sensor 75.

The acceleration detecting sensor 75 detects the axis of the sleeve 12 and a vertical acceleration. A frequency of a signal obtained from the acceleration detecting sensor 75 is analyzed at real time or a signal is stored in a memory, and then, its frequency is analyzed, so that only a multiple component of a rotational frequency is extracted. Multiple component to be extracted may be arbitrarily determined. The rotational speed detecting sensor 74 gives the rotational frequency component of the spindle 11. In the case where the size of the signal indicating the extracted multiple component is greater than a predetermined threshold as a result of comparison, a phase having a larger vibration in the spindle rotational direction is specified by the rotational speed detecting sensor 74, and then, the flow rate and direction of the air are determined in such a manner as to reduce the vibration of the phase. In the case of the consideration of both of the axis and the horizontal vibration, each of values may be set to become smaller by the use of the biaxial acceleration detecting sensor 75. Furthermore, several kinds of air supplying patterns are prepared in order to reduce the vibration, and then, the flow rate and direction of the air may be determined by testing the patterns in sequence. Alternatively, the air flow rate may be manually regulated in such a manner as to reduce the value of the vibration sensor while monitoring the value of the vibration.

Although the acceleration detecting sensor 75 is used as one example for obtaining the vibration in the present preferred embodiment, a sound pressure sensor and a displacement sensor may be used singly or in combination as unit for detecting information relating to the vibration.

What is claimed is:

1. A spindle device comprising:
supplying unit which supplies fluid from three or more points spaced in a circumferential direction between an outer race and an inner race of a bearing supporting a spindle; and
control unit which controls a supply quantity of fluid supplied by the supplying unit in such a manner as to independently vary the supply quantity at each of the supplying points.

2. A spindle device according to claim 1, wherein the supply quantity of fluid controlled by the control unit is determined based on a rotational speed of the spindle.

3. A spindle device according to claim 1, wherein the supply quantity of fluid controlled by the control unit is determined based on an inclination angle of the spindle.

4. A spindle device according to claim 1, further comprising:
a sensor which detects vibration of the spindle,
the supply quantity of fluid controlled by the control unit being determined based on a value detected by the sensor.
